(19) United States
(12) Patent Application Publication
(10) Pub. No.: US 2026/0352708 A1
(43) Pub. Date: Nov. 5, 2026

(54) SYSTEM AND METHOD TO DETECT AND MITIGATE LOCATION SIGNAL SPOOFING

(71) Applicants: Robert Bosch GmbH, Stuttgart (DE); Bosch Global Software Technologies Private Limited, Koramangala (IN)

(72) Inventors: Sumitra Biswal, East Delhi (IN); Abhishek Kumar, Muzaffarpur (IN); Gangaraju Maheshwari, Bangalore North (IN); Ganeshna Bharath Kalyan, Andhra Pradesh (IN); Subrata Abhijit Giri, Uttar Pradesh (IN); Thekkini Sasi Anish, Coimbatore (IN); Vishal Gupta, Uttar Pradesh (IN)

(21) Appl. No.: 19/661,389

(22) Filed: Apr. 28, 2026

(30) Foreign Application Priority Data
Apr. 30, 2025 (IN) 2025 4104 1529

(51) Int. Cl. H04L 9/40

(52) U.S. Cl. CPC H04L 63/1483; H04L 63/1425

(57) ABSTRACT

A system to detect and mitigate location signal spoofing is disclosed. The system includes a plurality of sensors configured to receive location signal data from a plurality of sources and network-based location verification. The system further includes a processing unit including a threat profiling engine configured to apply a multi-frequency and sensor fusion approach to verify integrity of received location signal data. The threat profiling engine detects spoofing and jamming activities based on verified location signal data using anomaly detection algorithms. The processing unit includes a mitigation engine configured to provide mitigation actions including alerting operators, recommending adjusted positioning, and logging data for forensic analysis.

This application claims priority under 35 U.S.C. §119 to application no. IN 2025 4104 1529, filed on Apr. 30, 2025 in India, the disclosure of which is incorporated herein by reference in its entirety

Embodiments of the present disclosure relates to spoofing attack prevention, and more particularly to, system and method to detect and mitigate location signal spoofing.

### BACKGROUND

Location-centric threats such as spoofing, jamming, and privacy invasion pose significant challenges to the accuracy, reliability, and security of Global Positioning System (GPS) and telematics-based navigation systems. These threats are particularly critical in sectors relying on precise location tracking, such as autonomous vehicles, fleet management, aviation, and military operations.

Current GPS security solutions suffer from several limitations, making them inadequate in preventing modern spoofing and interference attacks. Existing systems often fail to verify whether received GPS signals originate from legitimate sources, making them highly susceptible to spoofing and signal injection attacks. Most GPS receivers rely on single-frequency signals and lack multi-sensor fusion capabilities, rendering them incapable of distinguishing genuine signals from interference. Furthermore, traditional GPS systems use rule-based or threshold-based detection, which is ineffective against sophisticated AI-generated spoofing attacks. Many location-based services fail to incorporate granular privacy controls, exposing users to unauthorized tracking and potential data misuse. Moreover, present solutions are not designed to counteract AI-driven adversarial attacks, deepfake GPS signals, and evolving cyber threats targeting navigation systems.

Hence, there is a need for an improved system and method to detect and mitigate location signal spoofing to address the aforementioned issue(s).

### SUMMARY

In accordance with an embodiment of the present disclosure, a system to detect and mitigate location signal spoofing is provided. The present disclosure is a robust location security system that employs enhanced authentication protocols to verify GPS signals in real time, effectively detecting spoofing and jamming attempts. By utilizing a hybrid location tracking approach that integrates multi-frequency GPS and sensor fusion with tamper-proof logging, it ensures continuous and reliable tracking even in challenging environments with signal interference. Its AI-driven threat detection algorithms proactively analyze anomalies in location data, distinguishing between normal variations and potential attacks. Additionally, privacy-enhanced technologies safeguard user location data against unauthorized access, ensuring compliance with stringent data protection regulations. To address futuristic threats, the system leverages AI-powered detection mechanisms to counter adversarial GPS spoofing and deepfake-based location manipulations, providing a cutting-edge defense against evolving cyber threats in navigation systems.

### BRIEF DESCRIPTION OF THE DRAWINGS

An embodiment of the disclosure is described with reference to the following accompanying drawings:

FIG. 1 illustrates block diagram representation for a system to detect and mitigate location signal spoofing in accordance with an embodiment of the present disclosure;

FIG. 2 illustrates block diagram representation for a privacy-adaptive location data processing system in accordance with an embodiment of the present disclosure;

FIG. 3 illustrates an exemplary embodiment of the system of FIGS. 1 and 2, in accordance with an embodiment of the present disclosure; and

FIG. 4 is a flow chart representing the steps of a method for detecting and mitigating location data spoofing in accordance with an embodiment of the present disclosure.

### DETAILED DESCRIPTION

The present disclosure will now be described by way of example, with reference to accompanying drawings. Throughout all the figures, same or corresponding elements may generally be indicated by same reference numerals. These depicted embodiments are to be understood as illustrative of the disclosure and not as limiting in any way. It should also be understood that the figures are not necessarily to scale and that the embodiments are sometimes illustrated by graphic symbols, phantom lines, diagrammatic representations, and fragmentary views. In predetermined instances, details which are not necessary for an understanding of the present disclosure, or which render other details difficult to perceive may have been omitted.

Various embodiments of the present document may be implemented by software (for example, a program or an application) including one or more instructions stored in a storage medium (for example, a memory or) that may be read by a machine. For example, a processing unit of the machine may call at least one instruction among one or more instructions stored in the storage medium and may execute the instruction. This enables at least one function to be performed according to the at least one called instruction. The one or more instructions may include a code that is made by a compiler or a code that may be executed by an interpreter. The storage medium that may be read by the machine may be provided in the form of a non-transitory storage medium. Here, the "non-transitory storage medium" merely means that the storage medium is a tangible device and does not include a signal (for example, an electromagnetic wave), and with regard to the term, a case in which data is semi-permanently stored in the storage medium and a case in which data is temporarily stored in the storage medium are not distinguished from each other.

Embodiments of the present disclosure relates to a system and a method to detect and mitigate location data spoofing. As used herein, GPS spoofing involves the transmission of fraudulent satellite signals, tricking GPS receivers into calculating incorrect positions. This can result in misrouted deliveries, compromised fleet operations, and potential navigation failures in autonomous vehicles. Similarly, jamming disrupts the reception of legitimate signals, leading to navigation errors, loss of positioning accuracy, and potential safety hazards such as vehicle collisions. Privacy invasion occurs when unauthorized entities access or manipulate location data, leading to data breaches, user tracking, and non-compliance with privacy regulations such as GDPR and CCPA. Embodiments of the system are described below in more detail with the appended figures.

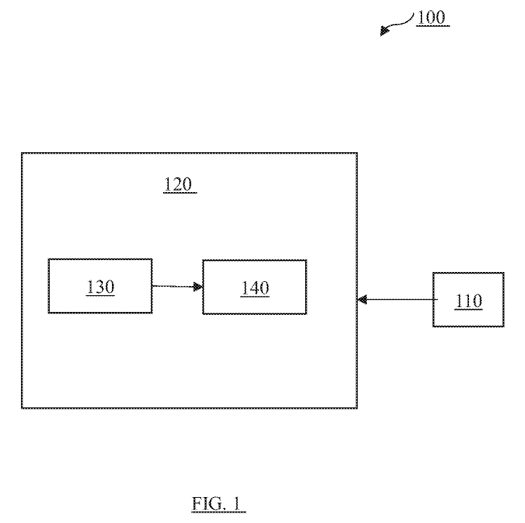

FIG. 1 is a block diagram representation of a system (100) to detect and mitigate location signal spoofing in accordance with an embodiment of the present disclosure. The system (100) includes a plurality of sensors (110) configured to receive location signal data from a plurality of sources and network-based location verification. This feature ensures that location signals received from multiple sources are verified for authenticity in real-time. It combines data from GPS, accelerometer, gyroscope, compass, and network-based location verification (e.g., Wi-Fi, LTE). This reduces the chances of location spoofing by cross verifying the signals from different sources and analyzing any discrepancies. The GPS signals and location data are validated against multiple sources before being accepted as legitimate. This prevents GPS spoofing attacks, where false signals mislead a system into calculating an incorrect location. In one embodiment, the multiple source verification includes cross validating GPS signals with sensor fusion data (accelerometer, gyroscope, network signals, etc.) and implementing digital signatures or cryptographic keys to verify the authenticity of GPS signals.

Furthermore, the system (100) includes a processing unit (120) coupled with the plurality of sensors (110). The processing unit (120) is configured to work in a hybrid mode of location tracking ensures continuous and seamless GPS functionality, even in blind spots or signal-interference environments. This is achieved by integrating multi-frequency GPS tracking, sensor fusion, and tamper-proof location logging. As used herein, blind spots are areas where GPS signals are weak or absent, such as tunnels, urban canyons, and underground parking, signal interference is disruptions caused by environmental factors or malicious jamming attacks and tamper-proof logging include secure record of location data that cannot be altered without detection.

The hybrid mode includes offline and online modes. In offline mode, the system logs data locally in a tamper-proof manner, allowing deferred verification and forensic analysis. In online mode, real-time spoofing detection and intrusion alerts are generated. A key advantage is that if a device loses connectivity, it continues tracking location changes and verifies them once connectivity is restored. In practice, offline mode can be useful in military applications, remote operations, or high-security areas where real-time communication is unavailable or restricted.

The processing unit (120) includes a threat profiling engine (130) configured to apply a multi-frequency and sensor fusion approach to verify integrity of received location signal data. The threat profiling engine is also configured to detect spoofing and jamming activities based on verified location signal data using anomaly detection algorithms. In detail, AI-based detection algorithms are employed to analyze incoming location data and detect potential threats. The system uses machine learning techniques, including supervised and unsupervised learning models, to distinguish between normal variations and malicious activity. The anomaly detection process involves examining GPS metadata, signal strength, Doppler shift, and historical movement trends. An example embodiment involves using ensemble models, such as Random Forests and Neural Networks, trained on real-world and synthetic spoofing scenarios, improving their ability to detect sophisticated attacks, including adversarial GPS tampering. The training dataset includes a curated mix of real-world GPS anomalies and synthetically generated spoofing scenarios, covering partial spoofing, meaconing, deepfake signals, and jamming attempts to enable the AI module to generalize across diverse adversarial patterns. Such algorithms dynamically adapt to identify abnormal patterns that could indicate an attack. The pattern recognition techniques include identifying repeated attack patterns such as meaconing (delayed GPS signals) and the real-time threat analysis include continuously monitoring Doppler shift variations, signal consistency, and movement feasibility.

The system (100) ensures reliability by cross-referencing multiple sensors, such as GPS, accelerometers, and odometers, to confirm location validity. For example, if a GPS signal suggests an abrupt change in location that contradicts inertial sensor data, the system flags it as a potential spoofing attempt. This feature is crucial for autonomous vehicles, aviation, and military applications, where accurate positioning is essential for safe operations. Each location data point is assigned a confidence score based on correlation with sensor inputs, historical trends, and environmental factors. If the score drops below a threshold, it triggers alerts or shifts to alternate positioning methods. Additionally, the confidence scores influence the severity level of alerts generated and are securely logged to support continuous learning and forensic auditing. This approach helps minimize false positives and ensures only significant threats are acted upon. In an embodiment, a fleet management system may use this feature to prioritize real-time tracking accuracy in high-risk areas. If multiple spoofing attempts occur in a specific region, the system generates a geo-threat map. This enables proactive security measures by marking high-risk areas for location manipulation attacks. Law enforcement and cybersecurity agencies can use this feature to track emerging threats and improve situational awareness in vulnerable zones.

In one embodiment, the AI module dynamically adapts to emerging GPS spoofing threats using continuous learning techniques. It classifies spoofing types such as partial spoofing, complete spoofing, and meaconing (signal interception and retransmission). The system then applies mitigation strategies, such as switching to alternate sources like Wi-Fi or inertial sensors, to maintain accurate tracking. One embodiment involves an autonomous drone navigation system that detects GPS anomalies and automatically switches to visual-inertial odometry to prevent mission disruption. In some embodiments, the threat profiling engine (130) assigns probability scores to detected anomalies, allowing operators to respond proportionately. For example, a minor deviation in GPS data may warrant monitoring, whereas a confirmed spoofing attack would trigger immediate security countermeasures. This layered response approach minimizes unnecessary alerts while ensuring timely intervention in critical situations.

Additionally, the processing unit (120) includes a mitigation engine (140) configured to provide mitigation actions comprising alerting operators, recommending adjusted positioning, and logging data for forensic analysis. In one embodiment, the mitigation engine (140) is configured to perform auto-correction of spoofed location data using historical movement patterns and cross-validation with network-based positioning systems. More specifically, upon detection of an anomaly or malicious activity in the location signals (e.g., a spoofed GPS input), the mitigation engine (140) generates real-time alerts to notify relevant stakeholders. In one embodiment, the alerts may be sent via visual dashboards, SMS/email notifications, or in-system warnings. The severity of the alert is classified based on predefined threat levels (e.g., low, medium, high). In such an embodiment, the alert includes contextual information, such as the type of anomaly detected, current location, signal source ID, and suggested response.

The mitigation engine (140) provides recommendations for alternative positioning sources or corrections when location reliability is compromised. It offers guidance to switch to or integrate alternate sources like cellular triangulation (3G, 4G, 5G), Wi-Fi access point location data, inertial navigation systems (INS) and pre-mapped geographic data. As used herein, the INS is a navigation aid that uses motion sensors (accelerometers and gyroscopes) to calculate position, orientation, and velocity. The engine (140) assesses signal credibility using multi-source data validation. If spoofed data is identified, it isolates the compromised input. It recommends a recalculated position based on corroborated sources. All detected threats and corresponding system responses are securely logged to create a forensic trace. This capability supports investigations of coordinated attacks, regulatory reporting, and continuous improvement of threat detection algorithms. In one embodiment, the mitigation engine (140) is enhanced with auto-correction capabilities, allowing it to autonomously correct spoofed or unreliable GPS data in real time.

Conclusively, signal strength, Doppler shift, multipath effects from GPS and sensor fusion data are extracted. The system (100) analyzes real-time patterns and compare them against historical behavior. The system uses classification models (for example: Random Forest, SVM, Neural Networks) to determine if the signal is likely spoofed. Further, the mitigation engine (140) trigger alerts when confidence scores indicate high spoofing probability and continuously retrain AI models based on new spoofing attempts detected in the system.

Moreover, the system (100) is designed to combat AI-powered location threats, including adversarial GPS attacks and deepfake-based location manipulations. By leveraging AI detection techniques, it may distinguish between genuine and fabricated GPS data. In one embodiment, adversarial GPS spoofing detection include AI models trained on synthetic spoofed signals to recognize deepfake manipulations. The system (100) compares received GPS coordinates with known terrain maps to detect inconsistencies and continuously learning to improve detection of emerging threats. As used herein, deepfake location manipulation include synthetic GPS data designed to mimic real movement patterns and adversarial GPS attack is AI-generated false signals intended to bypass traditional spoofing detection methods.

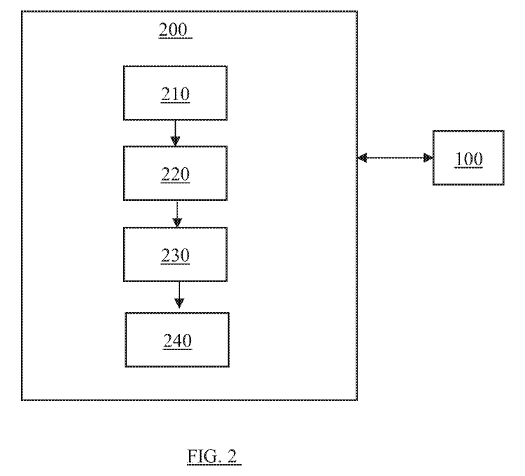

FIG. 2 illustrates block diagram representation of privacy adaptive location data processing system (200) in accordance with an embodiment of the present disclosure. This system (200) is designed to safeguard sensitive location data from unauthorized access or misuse, particularly in the context of privacy regulations (like GDPR, CCPA, etc.), evolving cybersecurity threats, and growing user awareness of digital privacy. It combines privacy assessment, preservation, controlled sharing, and intelligent monitoring to adaptively manage how location data is processed and accessed by the system (100). As used herein, the intelligent privacy adaptive routing (IPAR) is a mechanism to dynamically adjust location data precision based on context and privacy needs. This adaptive behavior is governed by the intelligent privacy adaptive routing (IPAR) sub-module, which dynamically determines the precision and frequency of location data sharing based on geographic sensitivity, operational relevance, user roles, and applicable privacy regulations. The processing system (200) include a privacy assessment module (210) configured to determine need of location data sharing based on user preferences and regulatory constraints. This module (210) acts as the system's decision-making brain to evaluate whether location data should be shared, and to what extent, by factoring in: whether the user consents to location sharing, how frequently, and at what precision, compliance with region-specific privacy laws (e.g., GDPR mandates explicit consent and purpose limitation). Specifically, it continuously assesses the data sharing context (e.g., is it for navigation, fleet monitoring, or emergency services). It categorizes requests into approved, conditionally approved, or denied, depending on user settings and applicable privacy rules.

The processing system (200) includes a privacy-preserving module (220) configured to apply granular location masking based on privacy settings. The privacy preserving module (220) is also configured to introduce differential privacy noise to prevent unauthorized tracking. The privacy preserving module (220) is further configured to use secure multi-party computation to process location data without exposing raw coordinates. As used herein, the multi-party computation (MPC) is a cryptographic technique that allows multiple parties to compute a function over their inputs without revealing them. This module (220) is responsible for modifying and securing location data before it is shared, using multiple advanced techniques. The module (220) modifies the accuracy of location data based on context. Instead of revealing exact GPS coordinates, the system may provide neighborhood-level precision, city-level summaries, approximate time-to-arrival estimates.

Furthermore, the module (220) applies controlled statistical noise to the location data before sharing, to prevent pattern-based re-identification and ensures that no single data point can be confidently linked to an individual. The module (220) also enables joint data analysis across multiple parties (e.g., logistics providers, city traffic departments) without sharing raw location coordinates. Specifically, the location data is encrypted and split into multiple parts. These parts are processed across separate computation nodes. The final result is obtained without exposing the original data to any single party.

The processing system (200) further includes a data-sharing module (230) configured to employ role-based access (RBAC) control to manage the location data accessibility. As used herein, the RBAC is a method of managing access to data or systems based on the roles of individual users. In one embodiment, fine-grained access policies can be configured (e.g., "Only managers can view real-time location") and access logs are maintained for each request.

Furthermore, the processing system (200) includes an unauthorized access detection module (240) configured to flag unusual requests for location data and triggers compliance alerts. In an embodiment, the alerting and compliance logging mechanism include generating audit trails of who accessed location data, when, and how and storing forensic records that support internal reviews or regulatory inspections. In some embodiments, the module (240) further enhances privacy by adapting data precision dynamically such as:

In high-security zones-- precise coordinates might be entirely masked.

For operational zones (like delivery areas)-- medium precision may be allowed.

In user-defined safe zones-- data might be shared more freely.

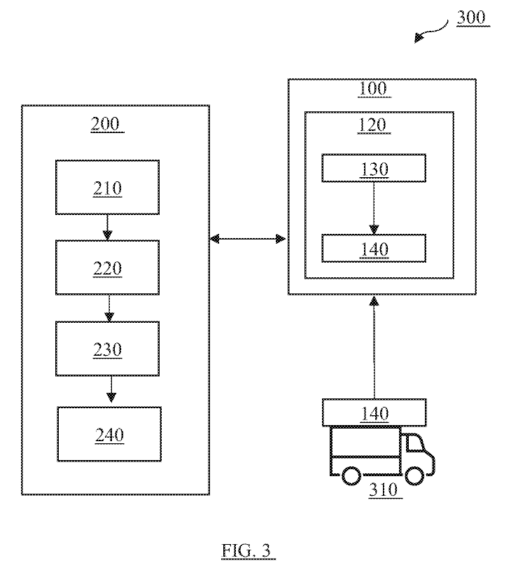

FIG. 3 is a schematic representation of an exemplary embodiment (300) of the system (100) of FIG. 1, in accordance with an embodiment of the present disclosure. Considering a non-limiting scenario, in a bustling metropolitan city, a leading e-commerce company deploys a fleet of autonomous delivery vehicles to ensure timely package deliveries. These vehicles rely heavily on GPS-based navigation systems for precise route planning, obstacle avoidance, and real-time traffic adjustments. However, due to the increasing prevalence of cyber threats, GPS spoofing, jamming attacks, and privacy intrusions, the security and reliability of the navigation system are at risk. The system (100) provides a robust solution to counteract these threats, ensuring secure and uninterrupted operations for autonomous vehicles. One of the delivery vehicle (310) is enroute to deliver a high-value package when a GPS spoofing attack is initiated by cybercriminals. The attackers transmit false GPS signals that attempt to redirect the vehicle (310) to a remote location for package theft. The authentication protocol immediately identifies the abnormality by cross-referencing GPS data with a plurality of sensors (110) from the vehicle’s accelerometer, gyroscope, and network signals. The threat profiling engine (130) of the processing unit (120) detects a sudden location jump that is inconsistent with the vehicle’s recent movement trajectory. The AI-powered verification assesses the signal origin, recognizing that it does not match legitimate satellite sources. The cryptographic authentication fails due to the absence of a valid digital signature on the spoofed signals.

Upon detecting the spoofing attempt, the mitigation engine (140) of the processing unit (120) rejects the false GPS data and switches to alternate positioning methods, such as network-based location tracking and motion sensor-derived movement estimation, allowing the vehicle to continue its journey without disruption.

In a scenario where the vehicle (310) moves through a tunnel, it temporarily loses direct GPS signals due to obstruction. However, the system (100) ensures seamless navigation continuity by employing a multi-frequency GPS system, sensor fusion, and tamper-proof location logging. The system (100) uses L5 GPS signals, which penetrate obstacles better than standard L1 signals. Inertial navigation (accelerometer + gyroscope) takes over, estimating the vehicle’s real-time position. The system (100) predicts the most likely path based on historical movement patterns and road topology. As soon as the vehicle exits the tunnel, GPS re-engages, and the system cross-verifies its calculated location with the latest satellite data to ensure accuracy. This hybrid mode prevents misrouting and eliminates errors caused by temporary signal loss.

In one embodiment, as the delivery vehicle (310) enters a high-risk area prone to cyberattacks, the threat profiling engine (130) proactively monitors GPS signal integrity and compares received signals with historical patterns. Suddenly, an attacker attempts a low-power jamming attack, trying to overwhelm the vehicle’s GPS receiver with interference. The threat profiling engine detects an abrupt signal strength fluctuation and an unusual increase in background noise. The AI-driven analysis flags the incident as a probable jamming attack based on past attack signatures. The mitigation engine (140) activates anti-jamming measures, filtering out interference and switching to alternate positioning sources such as cellular network triangulation. This ensures that even in hostile environments, the vehicle remains on course without losing navigation capabilities.

In one scenario, the delivery vehicle (310) carries sensitive customer data, including real-time location updates shared with fleet managers and customers. However, a hacker attempts to intercept location transmissions to track the vehicle’s route and predict high-value deliveries. The system (200) encrypts location data before transmission, making it unreadable to unauthorized entities using the privacy assessment module (210). Differential privacy techniques introduce slight variations in shared location data, preventing precise tracking while maintaining operational functionality using the privacy preserving module (220). Role-Based Access Control (RBAC) ensures that only authorized personnel can access precise delivery locations, while customers receive approximate delivery timeframes without exposing exact coordinates using the data sharing module (230). This privacy-enhancing mechanism protects the company’s logistics operations from corporate espionage and unauthorized tracking using the unauthorized access detection module (240). As used herein, the privacy enhancing mechanism includes the technologies designed to protect personal data and ensure compliance with privacy regulations like GDPR and CCPA.

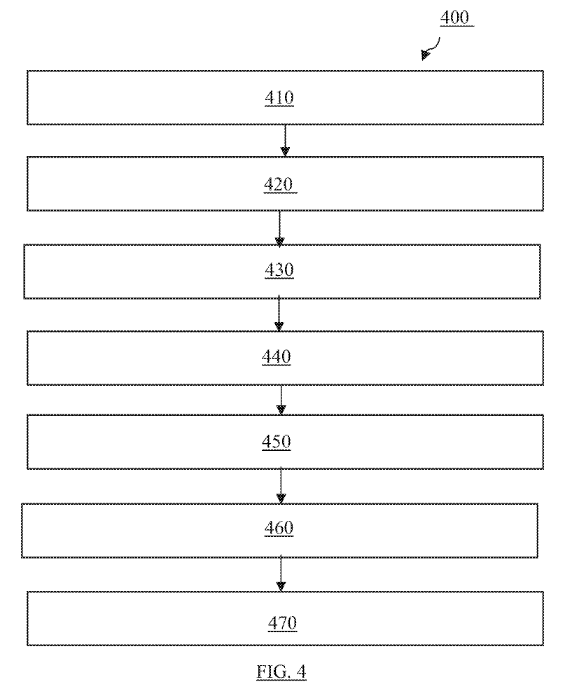

FIG. 4 is a flow chart representing the steps involved in a method (400) for detecting and mitigating location data spoofing accordance with an embodiment of the present disclosure. The method includes receiving location signal data from a plurality of sources and network-based location verification in step 410. In one embodiment, receiving location signal data from a plurality of sources includes satellite-based systems (such as GPS, Galileo, or GLONASS), as well as network-based location services like Wi-Fi positioning, LTE triangulation, or Bluetooth beacons. This multi-source architecture ensures that the system is not dependent on a single potentially compromised input and lays the foundation for resilient location verification.

The method (400) also includes collecting sensor fusion data from accelerometer, gyroscope, odometer, compass, and network signals in step 420. This data provides rich contextual information about the object's physical behavior including movement direction, orientation, speed, and inertial changes, enabling the system to build a cross-validated profile of actual vs. reported location activity.

Further, the method (400) includes extracting key location and movement features, including speed, direction, time deviation, and multipath effects in step 430. in such an embodiment, extracting may include system extracting key location and movement features, including but not limited to, velocity, direction of movement, time synchronization or deviation from expected timestamps, and multipath signal characteristics, which can reveal whether signals are being bounced off surfaces or manipulated by malicious entities. These features are then analyzed for anomalies, particularly focusing on signal inconsistencies, suspicious variations, or delays that deviate from known patterns of legitimate navigation behavior. For example, sudden unexplained jumps in location data, unexpected reversals in direction, or signal pathing incompatible with known geography could indicate a spoofing attempt.

The method (400) further includes analyzing anomalies in GPS signal characteristics to detect spoofing attempts in step 440. In one embodiment, analyzing the anomalies may include analyzing patterns in the location data to distinguish between normal variations and potential threats, cross-referencing the location signals with sensor data to detect inconsistencies, applying deviation thresholding to identify suspicious location jumps and utilizing AI-based pattern recognition to detect adversarial location data and deepfake attacks. In such an embodiment, if the GPS signal indicates rapid movement while the odometer reports negligible distance traveled, a spoofing attempt may be suspected. The method also employs threshold deviation detection, where any location shift exceeding expected tolerance levels triggers a flag and AI-based pattern recognition to specifically detect adversarial location data attacks or deepfake-style signal synthesis, where attackers use generative models to simulate realistic but false locations.

Moreover, the method (400) includes applying classification model to determine the likelihood of a spoofing attack in step 450. The method (400) further includes generating an anomaly probability score to assess the severity of the attack in step 460. In an embodiment, applying a trained AI-based classification model that evaluates the collected features and determines the likelihood of a spoofing attack. This model may be based on supervised learning techniques such as random forests, SVMs, or neural networks trained on historical spoofed and non-spoofed data. It produces an anomaly probability score, which reflects the severity or confidence level of a detected threat. A high score suggests a strong indication of spoofing, prompting the system to initiate mitigation.

Subsequently, the method (400) includes providing mitigation actions, including alerting operators, recommending adjusted positioning, and logging data for forensic analysis in step 470. The mitigation actions include a range of defensive and corrective measures, such as alerting operators (e.g., notifying fleet managers or vehicle systems), recommending adjusted or alternate positioning (derived from trusted sensor and network sources), and logging all events for forensic analysis and compliance review. This helps not only in reacting to immediate threats but also in preparing for regulatory audits and improving future models.

In some embodiments, the method (400) includes updating an adaptive model to retrain the classification models when new spoofing patterns are detected. When flagged anomalies are verified as attacks, these data points are fed back into the training pipeline, allowing the model to retrain and improve its detection accuracy. This adaptive modeling ensures that the system evolves alongside adversaries, maintaining its effectiveness against emerging threats such as AI-powered spoofing, RF manipulation, and synthetic location injection.

Various embodiments of the system to detect and mitigate location data spoofing enables a multi-layered security framework that enhances the reliability, accuracy, and resilience of location-based systems. It addresses the limitations of existing GPS and telematics solutions by integrating advanced authentication mechanisms, hybrid tracking approaches, AI-powered anomaly detection, privacy-enhanced technologies, and future-proof countermeasures against evolving threats. These technical advancements significantly improve the security of autonomous navigation, fleet management, and other location-dependent applications.

The system provides enhanced authentication protocols, which prevent GPS spoofing and jamming attacks. Traditional GPS receivers lack the ability to authenticate signals, making them susceptible to malicious broadcasting of false locations. The system solves this problem by implementing multi-source verification, cryptographic authentication of GPS signals and AI-based spoofing detection algorithms. This advancement enhances the accuracy and security of positioning systems, making them resilient to cyberattacks. Further, the system eliminates reliance on a single tracking technology, allowing autonomous vehicles, drones, and navigation systems to function reliably even in GPS-denied conditions.

Furthermore, the system provides AI-powered threat detection system, which dynamically analyzes GPS signals to detect and mitigate real-time attacks. This advancement significantly reduces false positives, improves response times, and strengthens cybersecurity in location-based applications. The system introduces advanced privacy-preserving technologies, ensuring that sensitive location data is secure and access-controlled. This advancement enables privacy-compliant location tracking while maintaining high security for commercial and governmental applications.

In addition, the system is designed to counter AI-powered threats through deepfake location detection, where AI models analyze signal consistency, movement feasibility, and terrain-matching discrepancies to reject manipulated GPS data. The AI-powered cross-validation with geospatial databases, ensuring that reported locations align with real-world geographical conditions. The adaptive AI learning, continuously updating detection models based on emerging GPS spoofing techniques. This future-proof security architecture ensures that autonomous vehicles, smart city infrastructures, and defense systems remain resilient against next-generation cyber threats.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A system to detect and mitigate location signal spoofing, comprising:
a plurality of sensors configured to receive location signal data from a plurality of sources and network-based location verification;
a processing unit coupled with the plurality of sensors, wherein the processing unit comprises:
a threat profiling engine configured to:
apply a multi-frequency and sensor fusion approach to verify integrity of received location signal data;
detect spoofing and jamming activities based on verified location signal data using anomaly detection algorithms; and
a mitigation engine configured to provide mitigation actions comprising alerting operators, recommending adjusted positioning, and logging data for forensic analysis.

2. The system as claimed in claim 1, wherein the processing unit is configured to work in at least two modes comprises:
an offline mode to record and validate location changes through tamper-proof logging and deferred AI-driven analysis; and
an online mode to provide real-time spoofing detection and intrusion alerts by continuously analyzing geolocation anomalies.

3. The system as claimed in claim 1, wherein the threat profiling engine is configured to assign a confidence score to potential GPS spoofing attempts based on anomalies in signal strength, Doppler variations, and inconsistencies in movement.

4. The system as claimed in claim 1, wherein the mitigation engine is configured to perform auto-correction of spoofed location data using historical movement patterns and cross-validation with network-based positioning systems.

5. A method for detecting and mitigating location data spoofing, comprising:
receiving location signal data from a plurality of sources and network-based location verification;
collecting sensor fusion data from accelerometer, gyroscope, odometer, compass, and network signals;
extracting key location and movement features, including speed, direction, time deviation, and multipath effects;
analyzing anomalies in GPS signal characteristics to detect spoofing attempts;
applying classification model to determine the likelihood of a spoofing attack;
generating an anomaly probability score to assess the severity of the attack; and
providing mitigation actions, including alerting operators, recommending adjusted positioning, and logging data for forensic analysis.

6. The method as claimed in claim 5, wherein analyzing the anomalies comprises:
analyzing patterns in the location data to distinguish between normal variations and potential threats;
cross-referencing the location signals with sensor data to detect inconsistencies;
applying deviation thresholding to identify suspicious location jumps; and
utilizing AI-based pattern recognition to detect adversarial location data and deepfake attacks.

7. The method as claimed in claim 5, comprising updating an adaptive model to retrain the classification models when new spoofing patterns are detected.

8. A privacy-adaptive location data processing system, comprising:
a privacy assessment module configured to determine need of location data sharing based on user preferences and regulatory constraints;
a privacy-preserving module configured to:
apply granular location masking based on privacy settings;
introduce differential privacy noise to prevent unauthorized tracking; and
use secure multi-party computation to process location data without exposing raw coordinates;
a data-sharing module configured to employ role-based access control to manage the location data accessibility; and
an unauthorized access detection module configured to flag unusual requests for location data and trigger compliance alerts.

9. The system as claimed in claim 8, wherein the location data is shared with varying levels of precision based on security zones, operational needs, and user preferences.

10. The system as claimed in claim 8, wherein the unauthorized access detection module is configured to enable an alerting and compliance logging mechanism to generate audit trails to track location data access and detect anomalies.
